(19) United States
(12) Patent Application Publication
(10) Pub. No.: US 2012/0290416 A1
(43) Pub. Date: Nov. 15, 2012

(54) SYSTEMS, METHODS AND PROCESSOR-READABLE MEDIA FOR CONVERTING COINS TO ELECTRONIC FUNDS DEPOSITED WITH AN ACCOUNT ASSOCIATED WITH A USER AT A POINT OF SALE

(75) Inventors: James Luevane, El Paso, TX (US); Luis M. Ortiz, Albuquerque, NM (US)

(73) Assignee: Inicia IP Holdings, LLC.

(21) Appl. No.: 13/116,476

(22) Filed: May 26, 2011

Related U.S. Application Data
(60) Provisional application No. 61/484,448, filed on May 10, 2011.

(51) Int. Cl. G06Q 20/00; G06Q 40/00

(52) U.S. Cl. 705/16

(57) ABSTRACT

Methods, systems and processor-readable media for converting coins at a point-of-sale into electronic funds. Cash can be accepted from a payer for payment of a transaction at a point-of-sale together with identifying information for a virtual coin purse associated with the payer. An amount due for payment and an amount due as change for a settlement of the transaction at the point-of-sale can be reconciled. The virtual coin purse associated with the payer can be credited in a form of electronic funds for change due in lieu of coins with respect to the transaction. The amount due as change, an amount due as bills, and an amount due as the coins can be categorized. Bills can be provided to the payer and the amount due as coins are then directed as electronic funds to the virtual coin purse.

### CROSS-REFERENCE TO PROVISIONAL APPLICATION

This patent application claims the benefit under 35 U.S.C. §119(e) of U.S. Provisional Application Ser. No. 61/484,448 entitled, “Systems, Methods and Processor-Readable Media for Converting Coins to Electronic Funds Deposited with an Account Associated with a User at a Point of Sale,” which was filed on May 10, 2011 and is incorporated herein by reference in its entirety.

### TECHNICAL FIELD

Embodiments are generally related to electronic commerce (hereinafter referred to as “e-commerce”) and cash management. Embodiments are also related to the conversion of coins into electronic currency. Embodiments are additionally related to the fields of electronic cash, retail/wholesale commerce, and wealth management. Embodiments are also related to virtual coin purse applications, methods, and systems.

### BACKGROUND OF THE INVENTION

The recent down-shift in customer economic confidence, mainly due to high unemployment, and the higher cost of living expenses, has forced the majority of people to find ways to maximize their available funds whenever possible, either by making more, spending less or maximizing what they have. For the average person, making the most of money earned is a primary consideration.

When a corporation or large businesses spends money, for example, they use funds management tools to optimize their spending. Wire transfers, ACH transfers, and BAI formatted account balance information files keep today's major businesses on the cutting edge of funds availability. Those funds are invested or deposited to gain interest income for these businesses, generating billions of dollars. “Cash Management” is therefore a major discipline in today's business environment.

Today, in a consumer transaction, every cash sale creates change and the majority of them include coins, There are over 2.585 trillion U.S. coins in circulation at any given point. These coins are stored in places such as homes, offices, cars, and sofas across the country. The majority of stored coins ultimately are traded for paper currency or “cashed in” when the amount of coins is overwhelming storage capabilities, or the need for an easier currency format (paper) is needed.

The process of converting change from cash transactions to paper currency, or the depositing of the change involves the accumulation and storage of change, its transport to an institution for processing, and fees associated with the conversion, making the process a passive one. These out of circulation coins could be generating interest and making wealth if deposited or invested. There are potentially millions of dollars in interest lost annually due to the amount of coins kept out of circulation.

Some attempts have been made to take advantage of this situation and recapture this “lost” coin currency. The well-known “Coinstar” system of Coinstar, Inc of Bellevue, Washington, U.S.A. is an example of kiosk-based approach. A typical “Coinstar” kiosk, painted green and the size of a large vending machine, is located at grocery stores, drug stores, larger merchants, banks or other retail locations. To process coins, one simply pours unsorted loose change into the machine. When the machine finishes counting coins, it issues a scrip called a voucher, which the user can redeem at the place of business providing the coin counting service at face value for currency.

The “Coinstar” approach involves many physical steps. That is, when a person converts their jar of change of accumulated coins into a redemption ticket at a coinstar machine usually/typically located in a grocery store, they will redeem the ticket for money which will typically also include coins. Therefore, the customer is still left with coins.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide the instantaneous processing of coins in a cash transaction.

It is another aspect of the disclosed embodiments to provide for improved e-commerce and cash management methods, systems and processor-readable media.

It is yet another aspect of the disclosed embodiments to provide improved methods, systems and processor-readable media for e-commerce, cash management, and the use of checking account/savings account/credit card information (“account information”) on a storage device suited for such applications (“fob”).

It is still another aspect of the disclosed embodiments to provide for improved e-commerce methods, systems and processor-readable that allows a user to convert physical currency to a format suitable for e-commerce for the purpose of cash management.

It is also an aspect of the disclosed embodiments to provide for methods, systems, and processor-readable media for the POS (point-of-sale) conversion of the physical balance of moneys returned when a sum tendered in payment is larger than the sum due (“change”) into an EFT formatted transaction set, which includes all “users” “change” transactions for the day for a single cash register/or local cluster, transmitted through current EFT systems (Visa, MC, etc,) to the users account as defined on the fob.

It is a further aspect of the disclosed embodiments to provide methods, systems and processor-readable media for electronic cash, retail/wholesale commerce, and wealth management.

The aforementioned aspects and other objectives and advantages can now be achieved as described herein. Methods, systems and processor-readable media are disclosed for converting coins at a point-of-sale into electronic funds. Cash can be accepted from a payer for payment of a transaction at a point-of-sale together with identifying information for a virtual coin purse associated with the payer. An amount due can then be reconciled for payment and an amount due as change for a settlement of the transaction at the point-of-sale. The virtual coin purse associated with the payer can then be credited in a form of electronic funds for change due in lieu of coins with respect to the transaction. Additionally, a categorizing operation can be implemented for categorizing the amount due as change and an amount due as bills and an amount due as the coins. The bills can then be provided to the payer and the amount due as coins directed automatically as electronic funds to the virtual coin purse.

In some embodiments, the virtual coin purse can be configured as an account stored in a server. In other embodiments, the virtual coin purse can be managed by a third-party provider. The third-party provider can be, for example, a financial institution, a credit card company, a coupon/redemption organization, a point/rewards provider, etc.

In some embodiments, the virtual coin purse can comprise data stored on a portable hand held device. Examples of such a portable hand held device include, but are not limited to, a Smartphone, a fob, a USB storage device, a Flash drive, a smart card, etc. Such a portable hand held device can be further configured to comprise bar code indicia associated with an account stored in a secured server.

Additionally, in some embodiments, the payer can be authenticated with respect to the transaction to ensure security of the financial transaction. Note that the point-of-sale can be, for example, an online store, a vending machine, a payment mechanism associated with public transportation, a cash register, etc.

In other embodiments, methods, systems and/or computer-readable media can be provided for engaging in a transaction using virtual funds. In such a situation, goods or services can be selected at a point-of-sale for a transaction. An amount due with respect to the goods or services selected can be received from the point-of-sale. Electronic cash can be provided from a virtual coin purse associated with a payer. The transaction can then be settled utilizing the electronic funds from the virtual coin purse. A current balance of the virtual coin purse can then be updated. As indicated above, examples of a point-of-sale include an online store, a vending machine, a payment mechanism associated with public transportation, a cash register, etc.

In some embodiments, the vending machine can include a data communication network connection in order to access a remote server containing account information associated with the virtual coin purse and a user interface to collect the account information associated with the virtual coin purse from a payer. In other embodiments, the account information can be provided from the payer via a biometric reading from the payer.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description herein, serve to explain the principles of the disclosed embodiments.

FIG. 1 illustrates current options available to a consumer at a POS facility, in accordance with the disclosed embodiments;

FIG. 2 depicts the two current options available to a consumer at a POS facility used to create a hybrid transaction, in accordance with the disclosed embodiments;

FIG. 3 depicts the hybrid transaction created by merging two existing POS options, in accordance with the disclosed embodiments;

FIG. 4 depicts the two current options available to a consumer at a POS facility used to create a hybrid transaction, illustrating where the two are combined, in the accordance with the disclosed embodiments;

FIG. 5 depicts a flow chart of logical operations detailing the transaction from the customer and clerks view, in accordance with the disclosed embodiments;

FIG. 6 depicts a cartoon depicting the transaction from the customer and clerks view, in accordance with the disclosed embodiments;

FIG. 7 depicts a sample receipt, in accordance with the disclosed embodiments;

FIG. 8 depicts a diagram illustrating the technologies by which a user's banking information stored on a fob is captured by the cash register via a credit card reader, in accordance with the disclosed embodiments;

FIG. 9 illustrates a sample “6” record which details the individual transaction information including name, financial institution's routing code, transaction code, and dollar amount, in accordance with the disclosed embodiments;

FIG. 10 illustrates a sample boilerplate ACH formatted file, void of any customers transactional information in the template, and one detail transaction record, in accordance with the disclosed embodiments;

FIG. 11 depicts a sample ACH formatted file created by the CtW application detailing four transactions including the pre-notes to the customer's account to be processed by the upstream ACH processor, in accordance with the disclosed embodiments;

FIG. 12 depicts a sample ACH formatted file created by the CtW application detailing four transactions to be processed by the upstream ACH processor highlighting the effective entry date, in accordance with the disclosed embodiments;

FIG. 13 illustrates a sample ACH formatted file created by the CtW application with three detail transactions including the credits to the customer(s) account and the debit to CtW to be processed by the upstream ACH processor, in accordance with the disclosed embodiments;

FIG. 14 illustrates a sample ACH formatted file created by the CtW application with three detail transactions to be processed by the upstream ACH processor highlighting the effective entry date, in accordance with the disclosed embodiments;

FIG. 15 depicts the path a specific transaction set follows to arrive at the Federal Reserve Bank, through existing infrastructure, in accordance with the disclosed embodiments;

FIG. 16 depicts the path a specific transaction set follows on the transactions effective entry date to arrive at the customers designated institution and account through an existing infrastructure, in accordance with the disclosed embodiments;

FIG. 17 depicts the path a specific transaction set follows from the FRB on the transactions effective entry date to arrive at the customers designated institution and account through an existing infrastructure, in accordance with the disclosed embodiments;

FIG. 18 depicts a sample receipt, in accordance with the disclosed embodiments;

FIG. 19 illustrates a schematic diagram of a system, in accordance with the disclosed embodiments;

FIGS. 20-21 respectively illustrate schematic diagrams of systems indicating communication between the electronic payment network and a vending machine that communicates with an e-payment module and a credit card scanner/fob reader with respect to a portable hand held device, in accordance with the disclosed embodiments;

FIG. 22 illustrates a schematic diagram of a system, in accordance with the disclosed embodiments;

FIG. 23 illustrates a block diagram of a computer system that can be utilized to execute programming for executing the methods, systems, and/or processor-readable media disclosed herein; and

FIG. 24 depicts a graphical representation of a network of data-processing systems in which aspects of the disclosed embodiments may be implemented.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which are illustratively shown. The embodiments disclosed herein can be embodied in many different forms and should not be construed as limited to the embodiments set forth herein; rather, these embodiments are provided so that this disclosure will be thorough and complete and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the disclosed embodiments. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the disclosed embodiments belong. It will be further understood that terms such as those defined in commonly used dictionaries, should be interpreted as having a meaning that is consistent with their meaning in the context of the relevant art and will not be interpreted in an idealized or overly formal sense unless expressly so defined herein.

As will be appreciated by one skilled in the art, the present invention can be embodied as a method, system, and/or a processor-readable medium. Accordingly, the embodiments may take the form of an entire hardware application, an entire software embodiment or an embodiment combining software and hardware aspects all generally referred to herein as a “circuit” or “module.” Furthermore, the embodiments may take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, etc.

Computer program code for carrying out operations of the disclosed embodiments may be written in an object oriented programming language (e.g., Java, C++, etc.). The computer program code, however, for carrying out operations of the disclosed embodiments may also be written in conventional procedural programming languages such as the “C” programming language or in a visually oriented programming environment such as, for example, VisualBasic.

The program code may execute entirely on the user's computer, partly on the users computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, Wimax, 802.xx, and cellular network or the connection may be made to an external computer via most third party supported networks (for example, through the Internet using an Internet Service Provider).

The invention is described in part below with reference to flowchart illustrations and/or block diagrams of methods, systems, computer program products, and data structures according to embodiments of the invention. It will be understood that each block of the illustrations, and combinations of blocks, can be implemented by computer program instructions. These computer program instructions may be provided to a processor of a general purpose computer, special purpose computer, or other programmable data processing apparatus to produce a machine such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

The aforementioned down-shift in customer economic confidence, as well as the emergence of applicable technologies, enables the user to become active in wealth management by controlling whether or not change from a cash sale is to physically received or electronically deposited into a defined checking, savings or credit card account. The current trend towards technology and its use in convenient money management makes the use of personal data storage devices, such as a fob, increasingly popular.

The data on a fob, unlike other personal data storage devices that store data electronically, cannot be altered by the possessor. Additionally, a fob requires no technical ability or training to use. A typical fob for a user of the CtW application choosing to credit their bank, savings and loan, or Credit Union would be a chip with personal banking information like a routing and transit number (ABA number) and account number of the user's requested account of choice hardcoded onto the chip by its manufacturer to our specifications. A typical fob for our users choosing to credit their credit card accounts would consist of a chip with credit card information like a card number, CVV/CVC/CID number, and the expiration date of the requested credit card account of choice also hardcoded onto the chip by its manufacturer to our specifications. The default fob would be approximately the size of a nickel and would traditionally be kept on the user's keychain.

Fobs for charity organizations and such would be customized as best able by current fob manufacturer's capabilities to reflect that organizations logo or other design choice. Fobs are increasingly being used for corporate and private security control, GPS location services, and encrypted delivery of access codes to restricted systems to remote users. The fobs use RF technology to transmit the data encoded within the associated reader system, i.e.: the MasterCard® PayPass credit card reader. Based on the foregoing, it can be appreciated that a large number of fob users are increasingly relying on such devices to transmit a variety of personal and business information.

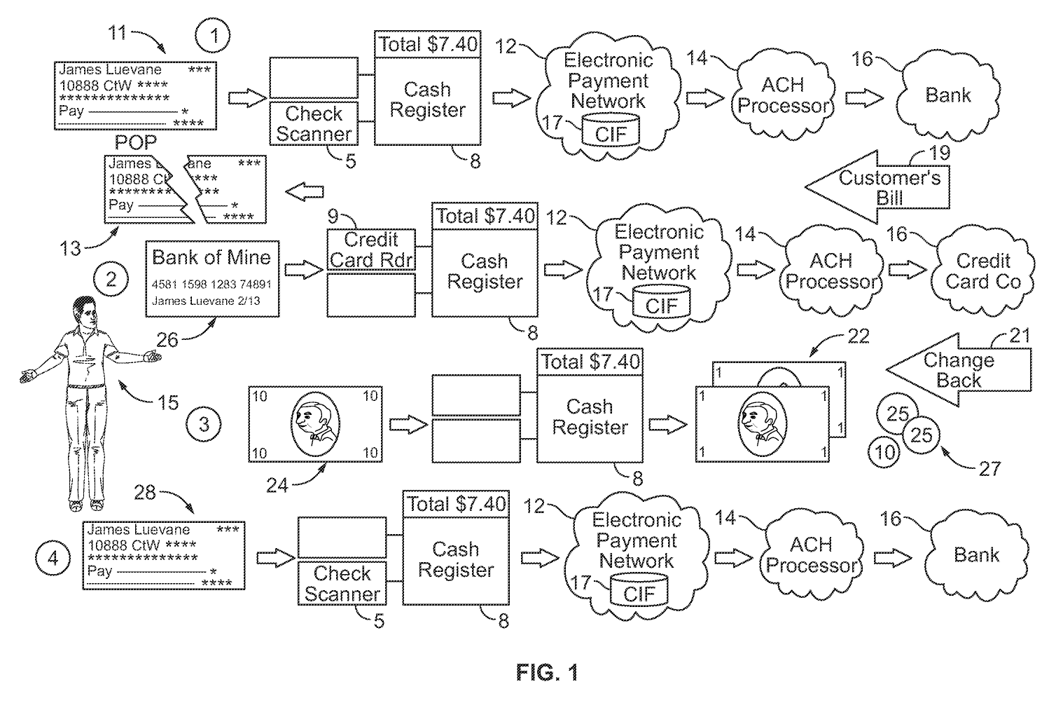

Most transactions today at a POS equipped store flow electronically through an electronic payment processing network. One example of such an electronic payment processing network is “VISAnet”, the most common of which is depicted in FIG. 1 herein. “VISAnet” includes data processing systems, networks, and operations which support and provide authorization services, clearing and settlement services, exception file services, and other services. Note that the reference to “VISAnet” as utilized herein is provided for general illustrative purposes and is not considered a limiting feature of the disclosed embodiments. Instead, any type of electronic payment process network can be utilized in accordance with the disclosed embodiments,

Transaction option 1 depicted in FIG. 1 illustrates a POP transaction, where the customer presents a blank check to the clerk who then scans the check using the check scanner attached to the cash register to create an EFT formatted file, or electronic funds transfer file. The scanned check is returned to the customer and the transaction is processed on the existing VISAnet infrastructure.

Transaction option 2 depicted in FIG. 1 illustrates a credit card transaction, where the credit card scanner attached to the cash register reads the card information via RF or scanner and creates a transaction that is transmitted to the customer's credit card company through the existing VISAnet infrastructure that the credit card company uses to charge the customer though the appropriate billing method.

Transaction payment option 3 depicted in FIG. 1 illustrates a cash transaction, where the customer presents the clerk with cash and the clerk uses the cash register to calculate the amount of change to return to the customer for a balanced transaction.

The 4th payment option illustrates a check being presented for payment. The check is scanned by the check scanner and the payment is electronically formatted and transmitted to the Federal Reserve Bank's clearing house for processing at the customers bank. Based on the foregoing, it can be appreciated that all payment transactions today at POS stores are supported and that cash registers systems support ACH transactions, i.e..: POS, CIE, POP, to support Point-of-Sale transactions and have the infrastructure to transmit the data to VISAnet. VISAnet has dedicated communications in place today to ACH processors like the Federal Reserve Bank, PACnet, and Sungard. Over 130 million transactions are processed daily through VISAnet as e-commerce and the conveniences associated with it are becoming a standard for today's consumer.

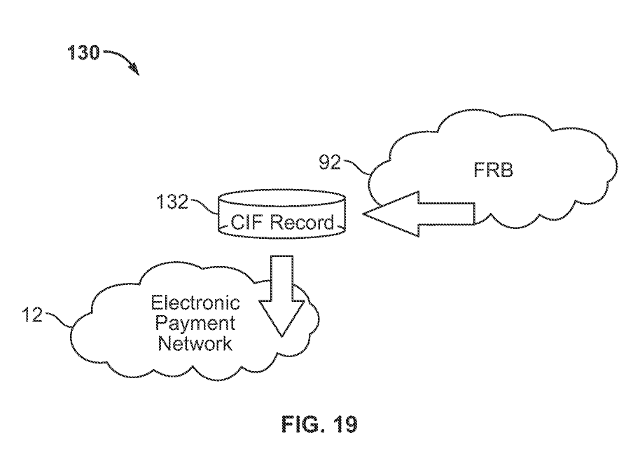

Cash registers utilized in the context of the disclosed embodiments may, in some cases, require a modification to its programming code assigning two currently unused keys to be labeled “CtW” and “Coin” respectively to accommodate the CtW application (i.e., an embodiment). During the sales process, for example, the customer hands cash to the clerk and the amount paid is applied to the amount due, potentially creating cash owed back to the customer. The programming of the cash register would be modified at the point of the clerk entering the amount of cash received by the customer. When the enter key is depressed, the programming then would cause the word “coin” to be shown, as well as the transaction total, on the registers LED. The clerk would then ask the customer their preference in receiving their change back. If the customer chooses to receive coin back, the clerk depresses the key labeled “coin” and the application ends. The clerk completes the transaction by giving the customer the amount of change due, in any appropriate denomination, and a receipt for the transaction. (e.g., FIG. 18)

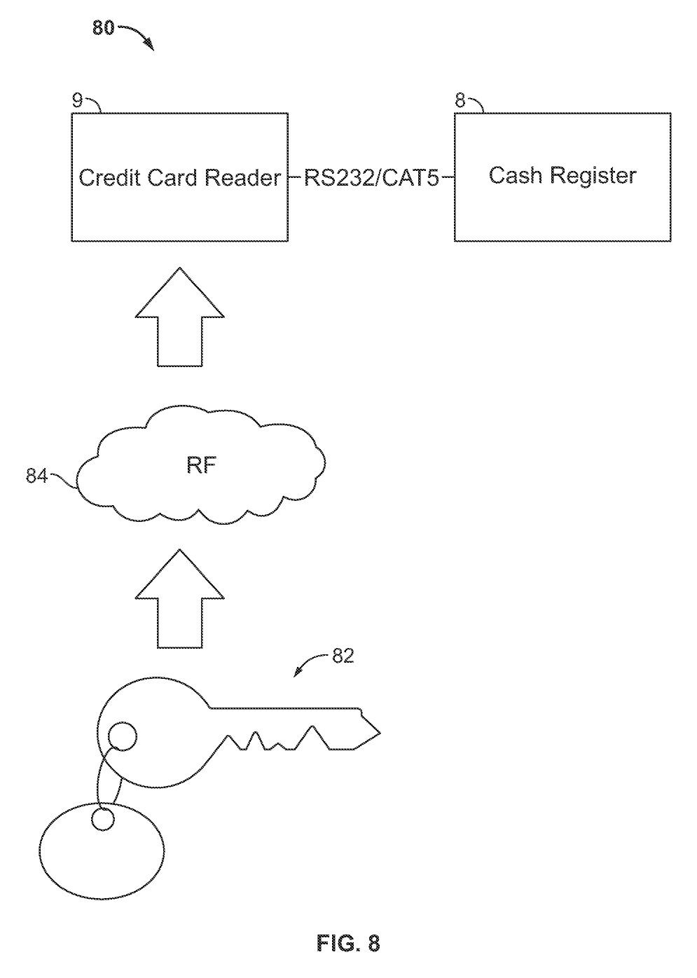

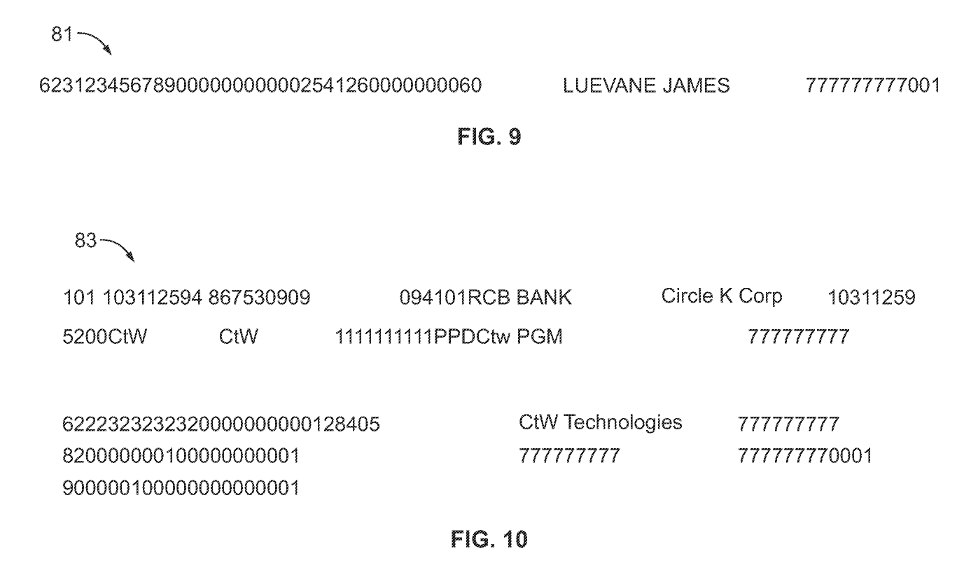

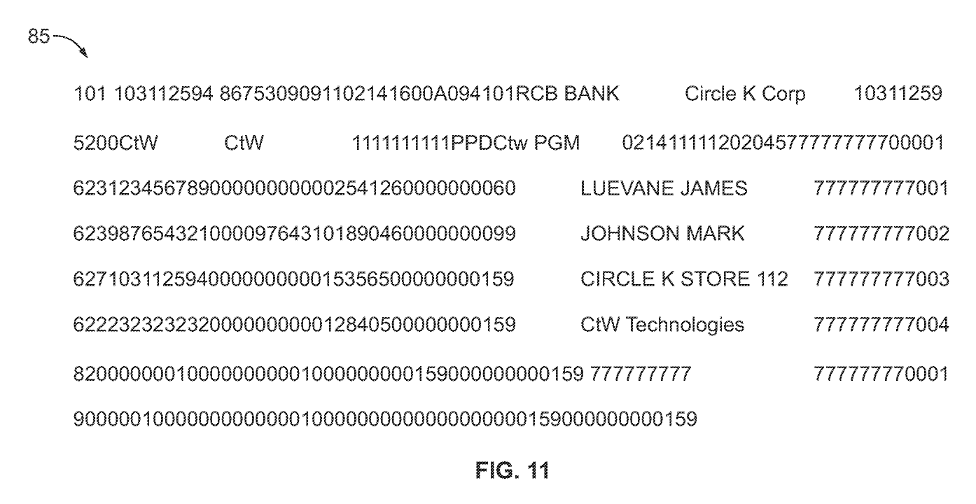

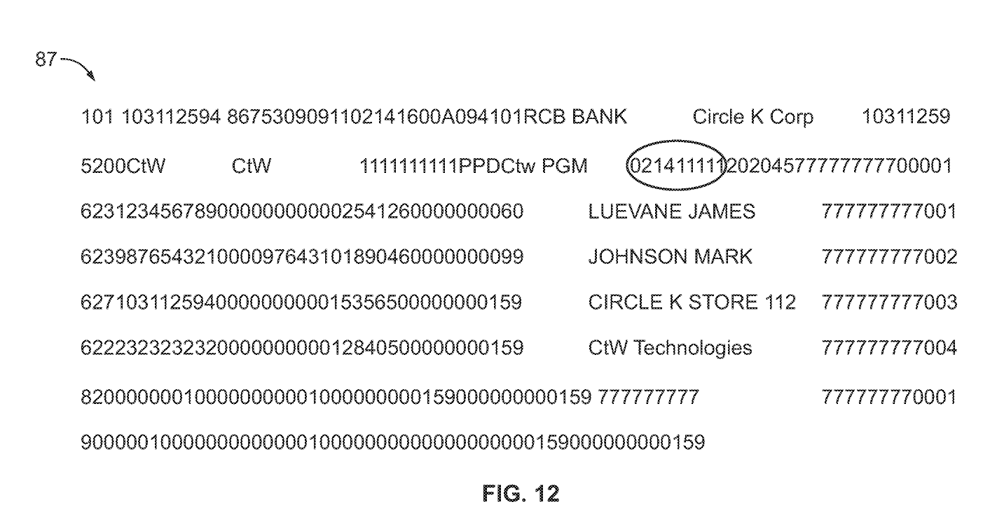

If the customer requests the coin be electronically deposited, the clerk can depress the “CtW” key and the programming would then display “swipe fob” on the registers LED. The customer would swipe the fob, allowing the credit card reader to capture the information stored on the fob via RF technology. (e.g., FIG. 8). The captured data (e.g., FIG. 9), along with all other captured data for the daily business cycle, is concatenated into a shell POP/PPD formatted ACH file (e.g., FIG. 10). The ACH file would contain a template of the appropriate ACH format and all of the CtW customer(s) data would be inserted into the template at End-of-Cycle AS A PRENOTE (e.g., FIG. 11).

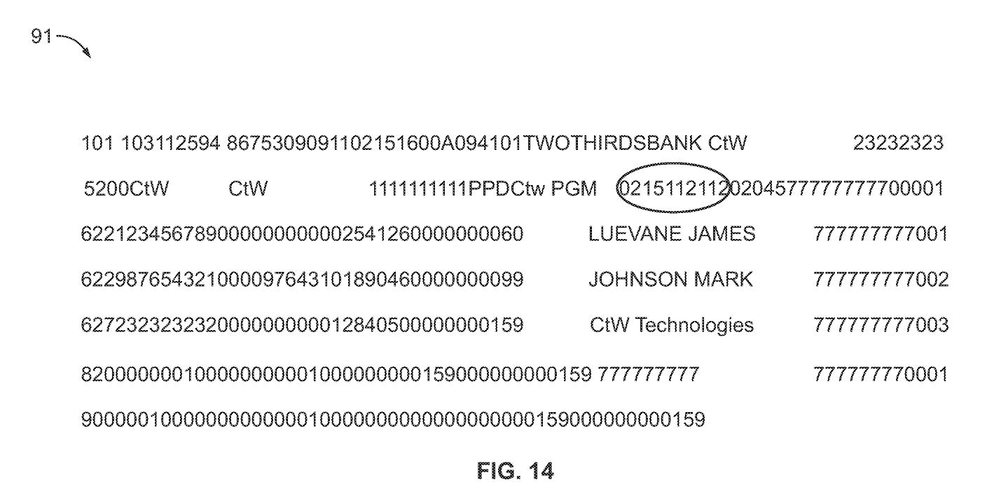

Two other hard-coded transactions can be included in the the a debit to the store for the total dollar amount of all CtW transactions for the day and a credit to CtW's account. Next, the CtW programming would copy the existing file and add one day to the Julian date, transaction date, and settlement date. The application would then change all transaction records with a pre-note to an active transaction code. The original debit to the store is deleted and the credit to CtW's account is made a debit (e.g., FIG. 13).

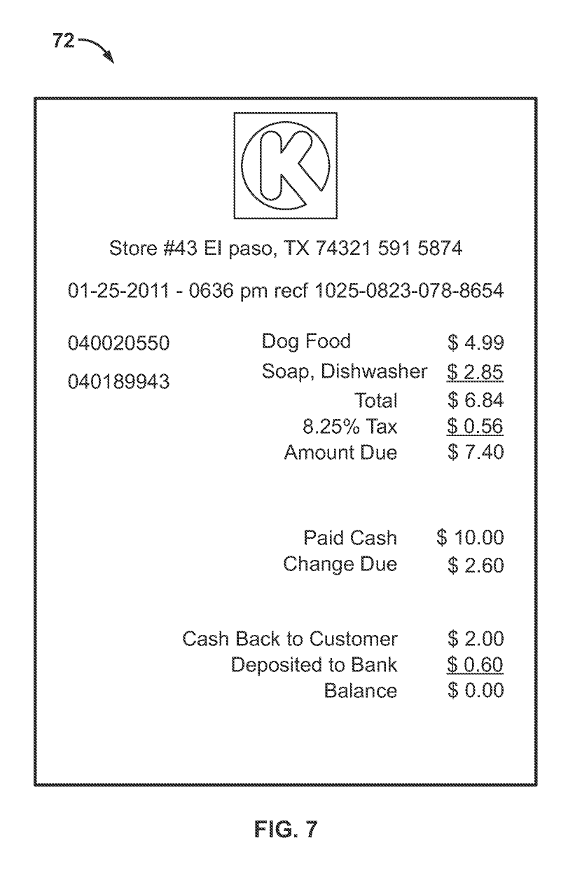

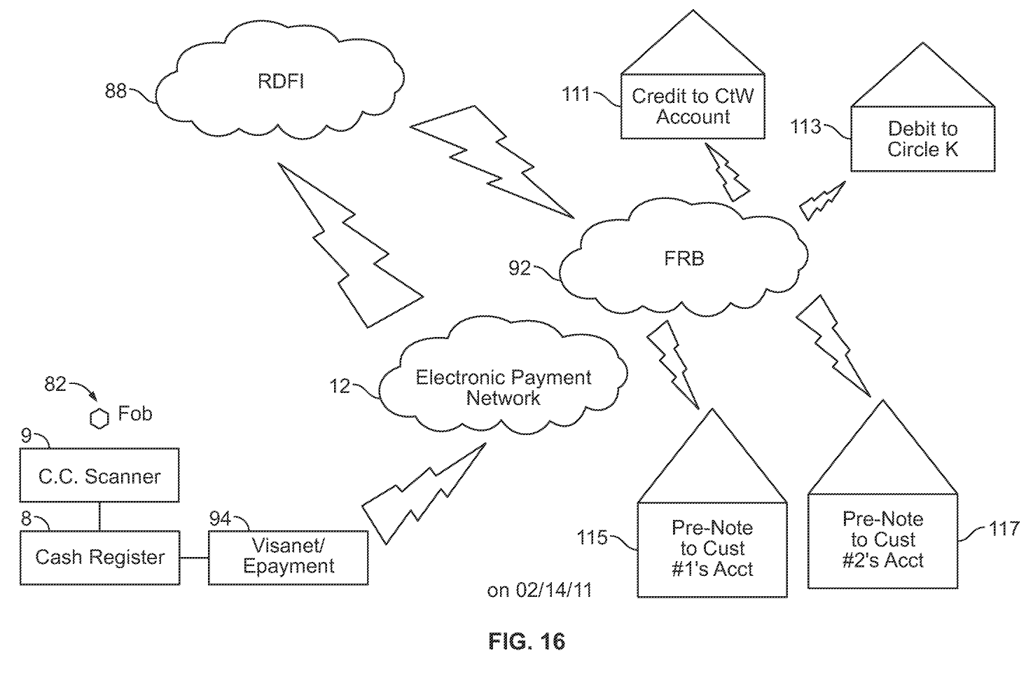

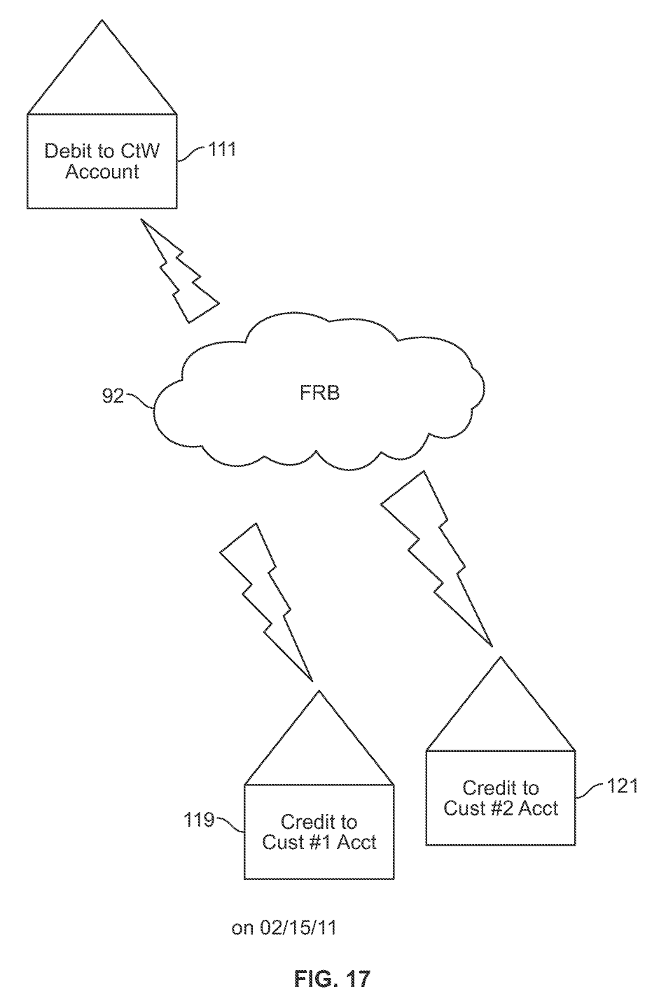

Finally, both files can be transmitted through, for example. VISAnet to ACH processor (e.g., FIGS. 15 and 16). Once verification of the files are wholly accepted is received, the application completes End of Cycle processing by deleting the two source files. The receipt of the transaction would reflect the cash back as well as the coin deposited (e.g., FIG. 7).

The ability to capture coin at the Point-Of-Sale, and transmit those funds electronically through the use of the process described herein, including the code and fob, would free individuals of the time consuming burden of gathering coin and securely storing the coin until such time as the coin is converted or deposited. Not only does the storage of coins keep those funds from being used, but it keeps those funds from generating interest income. Additionally, Point-of-Sale locations participating with CtW would significantly reduce or even eliminate the need for coin management and the need to have a large denomination of coin on hand. Additionally, the US government would benefit as well as the need to mint new coins would be significantly reduced. Additionally, charitable and other fund raising organizations could significantly increase its fund raising capabilities by using CtW. it will thus become apparent that disclosed embodiments, including alternative embodiments, can solve the traditional problems associated with the manual processing of coin.

FIG. 1 illustrates the four most currently utilized payment options utilized at locations equipped with Point-of-Sale equipment, in accordance with the disclosed embodiments. These are shown as Transactions 1, 2, 3, and 4 in FIG. 1. The first transaction 1 shown illustrates a check 11 presented for use in a “POP” ACH transaction, such transaction being defined as Point-of-Purchase, in which a check presented in-person to a merchant for purchase is processed as an ACH entry 11 instead of a physical check 13. The check 11 and/or the physical check 13 are associated with a user 15 desirous of a financial transaction. The transaction can be delivered electronically through an electronic payment network 12 in communication with a cash register 8 and then to an ACH processor 14 such as, for example, the Federal Reserve Bank to debit the account information that was captured during the check scanning process using conventional check scanners in the POP process. Note that the check scanning process can be provided via a check scanner 5 which communicates with the cash register 8. Additionally, the electronic payment network 12 can include a database 17 that includes at least one CIF (Customer Information File). The database 17 preferably includes multiple CIF's related to multiple users, not merely that associated with the user 15.

The second transaction 2 illustrated in FIG. 1 is a credit card transaction, which again can use the infrastructure of an electronic payment network 12 (e.g., VISAnet infrastructure) to electronically deliver the purchase information through the ACH processor 14 to the appropriate credit card company 16, where the credit card company 16 ultimately generates a bill to the customer for the charges incurred, which is indicated by arrow 19. Note that in the scenario of the second transaction 2, the cash register 8 can communicate with a credit card reader 9, which can “read” a credit card 26 associated with the user 15.

FIG. 1 further illustrates a third transaction 3, which is a cash transaction and is indicated by way of example, a $10,00 dollar sale and the associated return of the cash payment overage commonly known as “change” in the amount of $2.60. For example, a bill 24 is presented for a financial transaction (e.g., procurement of goods or services) at the cash register 8 (e.g., a POS), which results in change back as indicated by arrow 21, in the form of bills 22 and coins 27.

Finally, the fourth most common payment options at stores is the check payment, which is indicated by transaction 4 in FIG, 1. Here, the illustration shows a check 28 being read by the check scanner 5 connected to and in communication with the cash register 8. This paper check is either physically stored in the cash register 8 until the proprietor decides to have the checks deposited into the company's Financial Institution, or more commonly as of late, scanned and transmitted through the electronic payment network 12 (e.g., VISAnet) to the customer's bank 16, electronically.

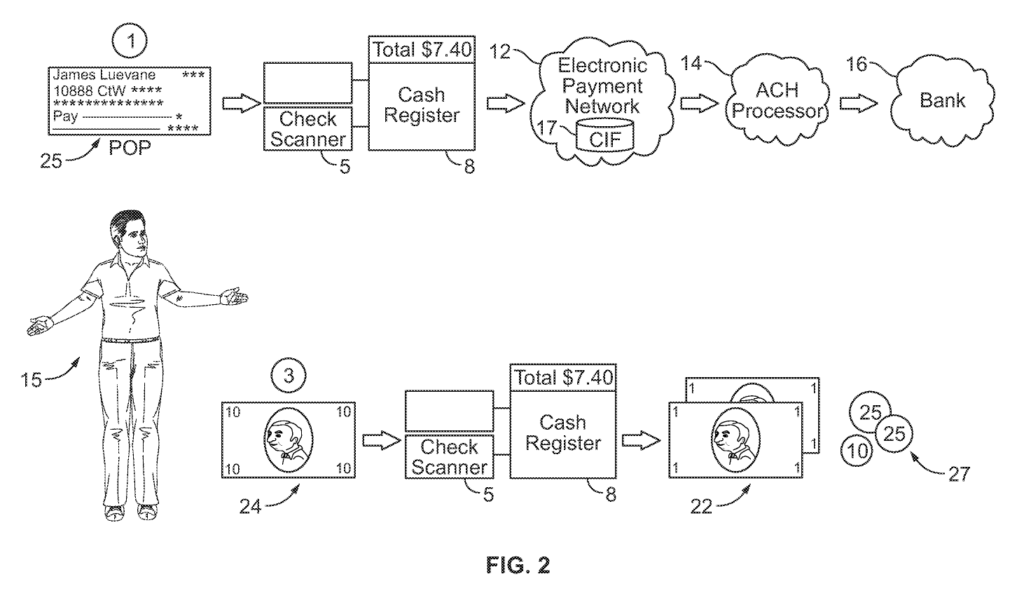

FIG. 2 illustrates the two payment options used to create a transaction, in accordance with the disclosed embodiments. Transaction 1 shown in FIG. 2 depicts a POP transaction, and the existing infrastructure it may follow to get to the associated bank and bank account, including VISAnet and an ACH processor or clearing house such as, for example, the Federal Reserve Bank, Sungard, and AcceptPay from, for example, American Express, and ultimately the customers Depository Financial Institution (DFI). The lower illustration of Transaction 3 depicts a bill 24 (e.g., $10.00 dollars) and the associated return of the cash payment overage commonly known as “change” in the amount of $2.60 as indicated graphically by bills 22 and coins 27 with respect to the cash register 8 and a check scanner 5.

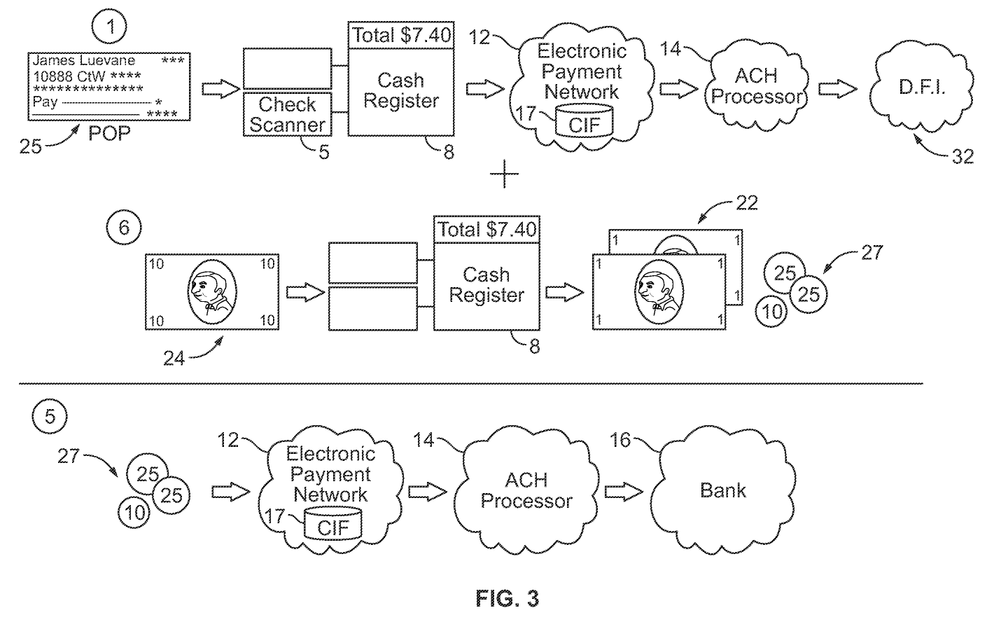

FIG. 3 illustrates two payment options that can be utilized to create a transaction, and as resulting hybrid transaction, in accordance with the disclosed embodiments. The illustrated transaction 1 shown in FIG. 3 depicts a POP transaction and the existing infrastructure it may follow to get to the associated bank and bank account including, for example, VISAnet, and an ACH processor 14 or clearing house such as, for example, the Federal Reserve Bank, Sungard, and AcceptPay from American Express, and ultimately the customers Depository Financial Institution (DFI) 32. The middle illustration 6 depicts a bill (or bills) 24 (e.g., $10.00 dollars) and the associated return of the cash payment overage commonly known as “change” in the amount of $2.60 as indicated by bills 22 and change 27.

The lower illustrated transaction 5 depicted in FIG. 3 represents a transaction involving the return of coin back from the aforementioned process and the path that coins 27 formatted as an EFT file would follow to get to the associated bank and bank account, including through the electronic payment network 12, the ACH processor 14 or clearing house such as the Federal Reserve Bank, Sungard, and AcceptPay from American Express, and ultimately the customers Depository Financial Institution (DFI), which is indicated as “bank 16” in FIG. 3. Note that the DFI 32 and the bank 16 can in some cases actually be the same institution.

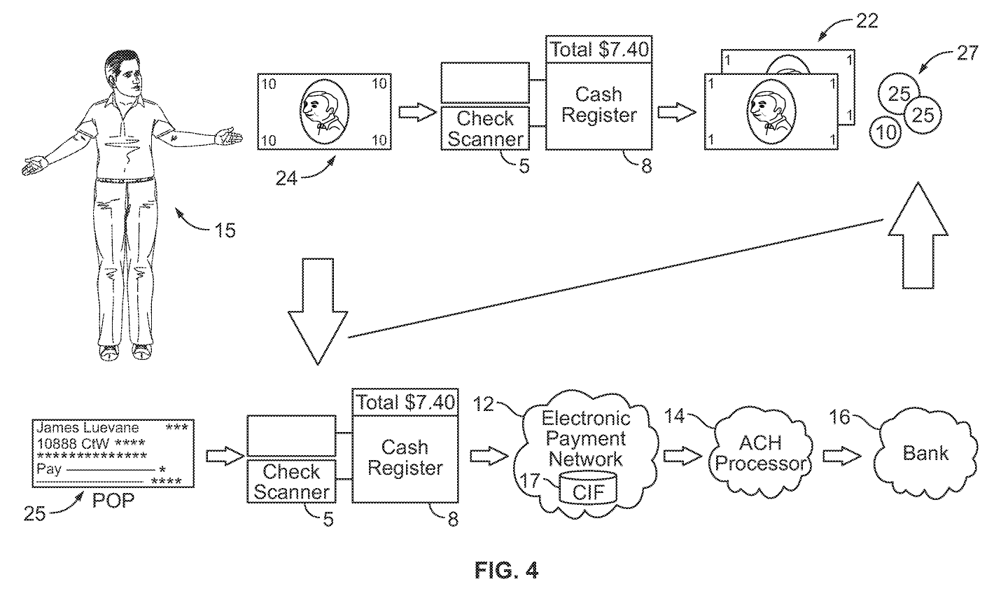

FIG. 4 illustrates a schematic diagram depicting an example of a $10.00 dollar transaction being processed through a cash register and the associated return of the cash payment overage commonly known as “change” in the amount of $2.60. The upper illustration in FIG. 4 shows a bill 24 (e.g., $10.00 bill) which is subject to a financial transaction via cash register 8, resulting in change in the form of bills 22 and coins 27.

The lower illustration depicted in FIG. 4 demonstrates the point within the current POP transaction process, whereby coin back from the aforementioned process and the path that coin formatted as an EFT file would follow to get to the associated bank and bank account, in accordance with the disclosed embodiments. Thus, the lower illustration of FIG. 4 depicts a POP check 25 with respect to a check scanner 5 and cash register 8. The electronic payment network 12 communicates with the cash register 8 and the ACH processor 14. In the lower illustration, the electronic payment network 12 is shown as the VISAnet configuration described earlier. The transaction passes from the network 12 to the ACH processor 14 (e.g., clearing house such as the Federal Reserve Bank, Sungard, and AcceptPay from American Express) and ultimately to the customers Depository Financial Institution (DFI) 16.

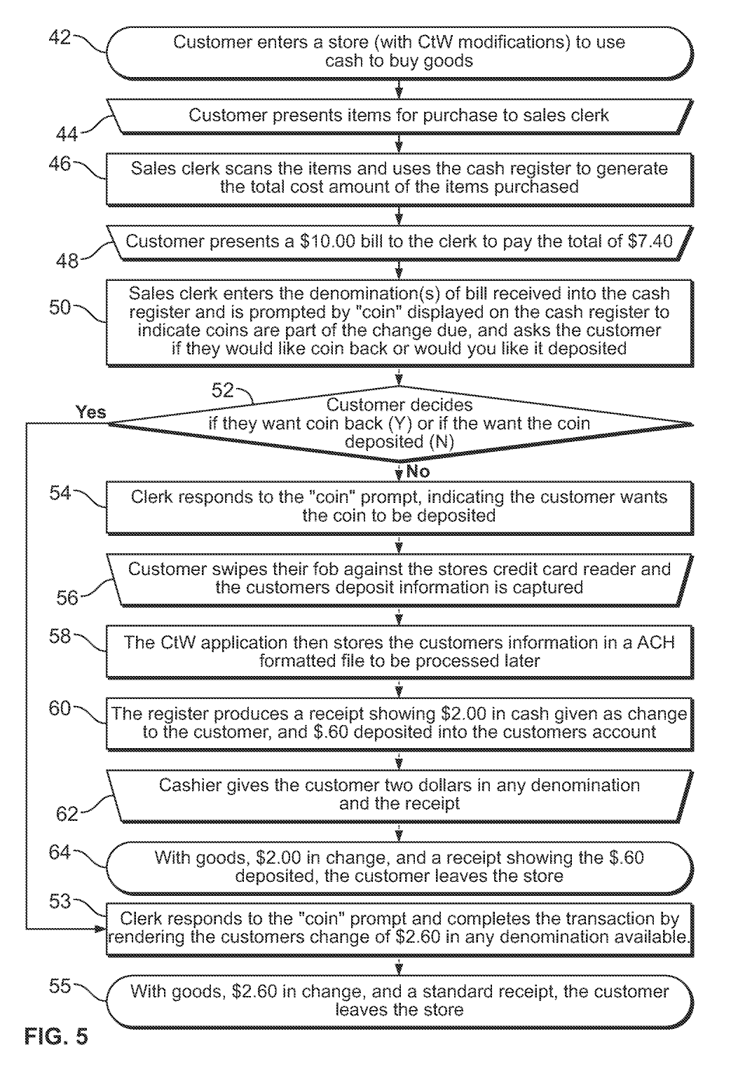

FIG. 5 depicts a flow chart of logical operational steps indicative of a method for implementing a financial transaction, in accordance with the disclosed embodiments. The method shown in FIG. 5 illustrates a sample transaction from the customer and clerks view, in accordance with the disclosed embodiments. As indicated at block 42, a customer or user such as user 15 shown earner can enter a POS (e.g., in this case a store) to use cash to buy goods. Next, as illustrated at block 44, the customer 15 presents items for purchase to, for example, a sales clerk. Thereafter, as shown at block 46, the sales clerk scans the items and uses the cash register 8 discussed above to generate the total cost amount of the items purchased.

Following the processing of the operation depicted at block 46, the customer 15 can present a bill (e.g., a $10.00 bill in this example scenario) to the clerk to pay a total of, for example, $7.40. Then, as shown at block 50, the sales clerk enters the denomination(s) of bills received into the cash register 8 and is prompted by “coin” displayed on the cash register 8 to indicate that coins are part of the change due and asks the customer 15 if he or she would like coin back or would like it deposited into a virtual coin purse (e.g., an electronic account) associated with the user/customer 15. Two options are then available as indicated at block 52. That is, the customer/user 15 can decide if he or she wants coin back (Y=Yes) or if they want the coin deposited into the aforementioned virtual coin purse (N=No). If the answer is “Yes”, then as depicted at block 53, the clerk responds to the “coin” prompt and completes the transaction by rendering the customers change of $2.60 in any denomination available. Thereafter, as illustrated at block 55, with goods, $2.60 in change, and a standard receipt, the customer leaves the store. Assuming, however, that the answer is “No” in response to the operation described at block 52, then as indicated at block 54, the clerk responds to the “coin” prompt, indicating that the customer wants the coin to be deposited in, for example, a virtual coin purse or other account associated with the user/customer 15.

Following the processing of the operation depicted at block 54, as indicated at block 56, the user/customer 15 can communicate his or her hand held portable device (e.g., a fob, smart card, smartphone, etc) with the stored reader and the customer's deposit information is captured. Note that in the case of a fob or smart card, the “communication” between the fob or smart card and the reader (e.g., a credit card reader) can occur with a swipe of the card or fob with respect to the reader. In the case of a smartphone, for example, such communication may take place wirelessly (e.g., wireless communication). In some cases, the aforementioned smart card may be an RFID enabled smart card and communication may take place via RFID communications.

Thereafter, as described at block 58, the disclosed application can store the customer's/user's information in an ACH formatted file to be processed later. Next, as shown at block 60, the register 8 can produce a receipt showing $2,00 in cash given as change to the customer/user 15 and $0.60 deposited into the customer's virtual coin purse or other electronic account. Following the processing of the operation shown at block 60, the operation at block 62 can be implemented in which the cashier gives the customer two dollars in any denomination and the aforementioned receipt. Finally, as shown at block 64, with goods, $2.00 in change, and a receipt showing the $0.60 deposited, the customer leaves the store.

In general, the oval shaped blocks in FIG. 5 represent the starting trigger and ending point respectively, while the polygons represent a manual process, rectangles represent a current business process, and the diamond represents a decision. Solid lines connecting these shapes indicate a current process flow, where dashed lines represent an alternative business process.

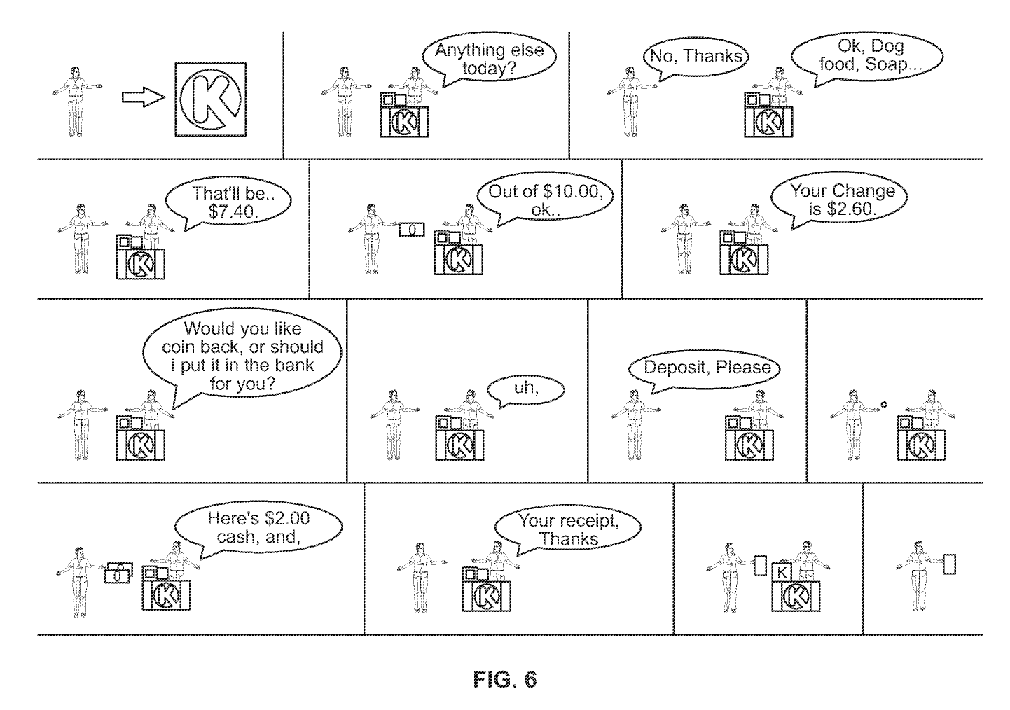

FIG. 6 depicts a graphical representation of a method for processing a financial operation in accordance with the disclosed embodiments. The graphical representation of FIG. 6 is generally a cartoon-style depiction of a sample transaction from the customer and clerks view. Each scene represents an event, in the appropriate timeline of the transaction, depicting the transaction and associated process each would undertake in such a transaction.

FIG. 7 depicts a sample receipt 72, in accordance with the disclosed embodiments. The sample receipt 72 shown in FIG. 7 is from a fictitious store #43 of the Circle K convenience store chain located in El Paso, Tex. The fictitious zip code and telephone number are included as well as two purchases totaling $6.84. In Texas, for example, a sales tax of 8.25% is applicable, the receipt reflects that tax amount of $0.56, and the total sale amount of $7.40. The amount of cash tendered and the change due the customer are printed as well. Lastly, the amount of change paid in cash and the amount electronically deposited to the customers bank account.

FIG. 8 illustrates a block diagram of a system 80, in accordance with the disclosed embodiments, As shown in FIG, 8, a keychain fob 82 is shown, which can communicate via RF communications 84 with a credit card reader 9, which in turn communicates with the cash register 8. System 80 demonstrates how a keychain, with a provided fob, can be “read” by the credit card reader 9 attached to the cash register 8 via, for example, a Cat 5/6 cable or RS232 cable using radio frequency technology, i.e., RF communications 84.

Data associated with and/or stored on the keychain fob 82 can be captured by the card reader 9 and then stored as a retail transaction record on, for example, the hard-drive of the cash register 8 in an applications program directory. When the end-of-cycle process executes, all captured transaction stored on such a hard drive (or other appropriate storage device such as a computer server) can be merged into a boilerplate ACH template file. Note that although a keychain fob 82 is shown in FIG. 8, it can be appreciated that other portable hand held devices can be utilized in place of the keychain fob 82. Examples of such portable hand held devices are smart cards, RHO enabled smart cards, smartphones, and so forth.

FIG. 9 illustrates a graphical representation of a sample “6” record or transaction detail record 81 as used in Automated Clearing House (ACH) formatted files, in accordance with the disclosed embodiments. The detail record 81 shown in FIG. 9 includes the details of the transaction including the record type code (6), the transaction code (23), the individuals 9 digit bank routing and transit number (123456789), the individuals account number at that bank (254126), the dollar amount of the transaction ($0.60), the individuals name (LUEVANE JAMES), and a trace number (777777777001).

FIG. 10 illustrates a graphical representation of a sample of an ACH boilerplate file 83 stored on the cash registers hard drive, in accordance with the disclosed embodiments, The ACH boilerplate the would be stored in the application's program directory that, once accessed by the applications end-of cycle process, would be populated by transaction details in the form of 6 records (see FIG. 9) including the record type code, the transaction code, the individuals 9 digit bank routing and transit number, the individuals account number at that bank, the dollar amount of the transaction, the individuals name, a trace number, and other ACH the requirements not already coded into the boilerplate including transmission date, transmission time, effective entry date, settlement date, trace number, entry addenda count, entry hash, total debit entry dollar amount in file, total credit entry dollar amount in file, and batch number.

FIG. 11 illustrates a graphical representation sample of the ACH file 85 created by the application's end-of-cycle process, in accordance with the disclosed embodiments. This sample ACH file 85 includes four transactions, wherein three of those transactions were created from stored transaction detail records (6 records) by running the end-of cycle process, and includes two pre-notes and two transaction that existed in the ACH Boilerplate file sans details, now completed by the end-of cycle process.

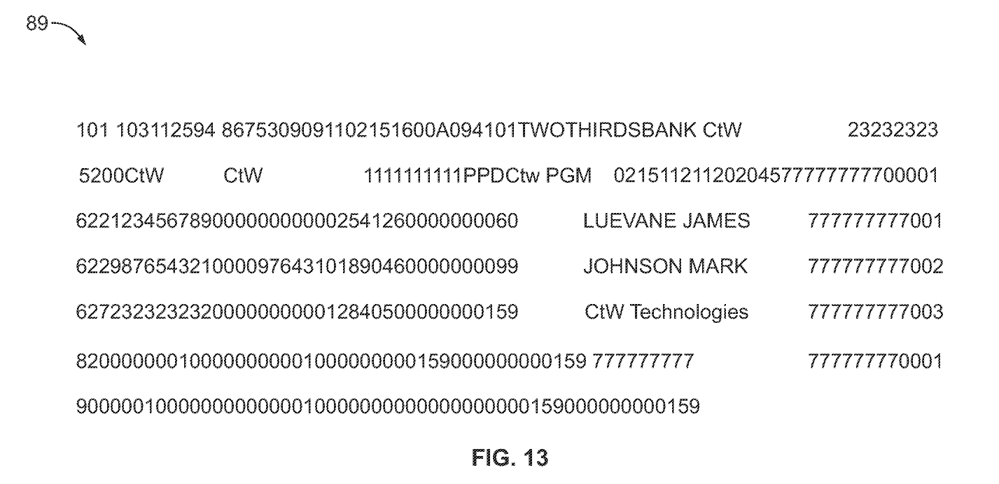

FIG. 12 is a graphical representation of a sample of the ACH file 87 created by the application's end-of-cycle process, in accordance with the disclosed embodiments. This sample file 87 has the effective entry date highlighted and includes four transactions, three of those transactions were created from stored transaction detail records (6 records) by running the end-of cycle process, and includes the two customer pre-note transactions and two transaction that existed in the ACH Boilerplate file sans details, now completed by the end-of cycle process. the debit to the store, and the credit to an account.

FIG. 13 illustrates a graphical representation of a sample of the ACH file 89 created by the application's end-of-cycle process, in accordance with the disclosed embodiments. This sample ACH file 89 includes three transactions, including the two customer credits, and one debit to the CtW account. This file is initially created by the application software associated with the disclosed embodiments during the End-of-Cycle, and is a copy of the original, but is modified so that the effective entry date and settlement dates are advanced, the “pre-note” transaction codes are converted to transaction codes, and the debit transaction is applied to the account associated with, for example, the user/customer 15.

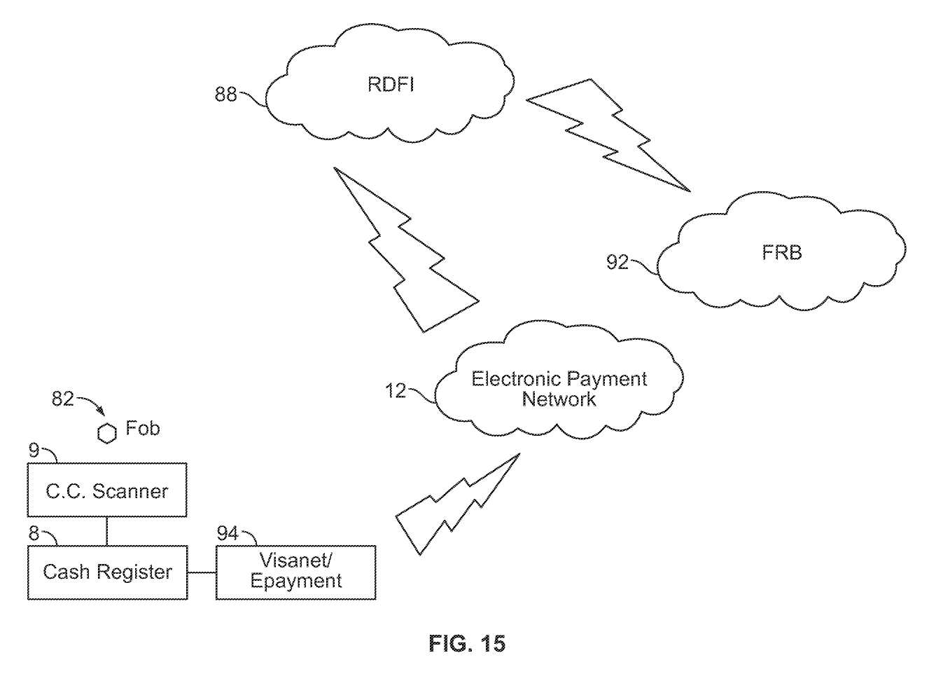

FIG. 14 illustrates a graphical representation of a sample of the ACH file 91 created by the application's end-of-cycle process, in accordance with the disclosed embodiments. This sample ACH file 91 shown in FIG. 14 can include the effective entry date highlighted and includes three transactions, including the two customer credits, and one debit to the account. This file is initially created by the application software during the End-of-Cycle and is a copy of the original, but is modified so that the effective entry date and settlement dates are advanced, the “pre-note” transaction codes are converted to transaction codes, and the debit transaction is applied to the account.

FIG. 15 illustrates a schematic diagram of the path that a specific transaction set follows to arrive at a Federal Reserve Bank 92 through an existing infrastructure, in accordance with the disclosed embodiments. In the configuration depicted in FIG. 15, the cash register 8 is shown connected to and/or in communication with credit card scanner/reader 9 and an e-payment communications module 94 (which may be hardware and/or software code). The portable hand held device 82 (e.g., fob) can communicate with the credit card scanner 9. The transaction would be created by the operator of the cash register 8 and uploaded from the electronic payment network 12 via the module 94 to the RDFI (Receiving Depository Financial Institution) 88, which “strips” the file of its customers transactions (on-us) and then sends the foreign items to the Federal Reserve Bank 92 for processing and/or warehousing.

FIG. 16 illustrates a schematic diagram of the path that a specific transaction set can follow from the Federal Reserve Bank 92 to an appropriate participant's account through the existing infrastructure, in accordance with the disclosed embodiments. As shown in FIG. 16, credit to an account or virtual coin purse is indicated by block 111. while credit to the store (e.g., Circle K) is indicated by block 113. A pre-note to the customer's #1 account is indicated by block 115 and a pre-note to the customer's #2 account is indicated by block 117. In the scenario depicted in FIG. 16, the transaction that was created by the cash register operator and uploaded to the Federal Reserve Bank 92 for processing was effective Feb. 14, 2011, and the graphic illustrates the FRB 92 releasing those transactions to the downstream DFI's.

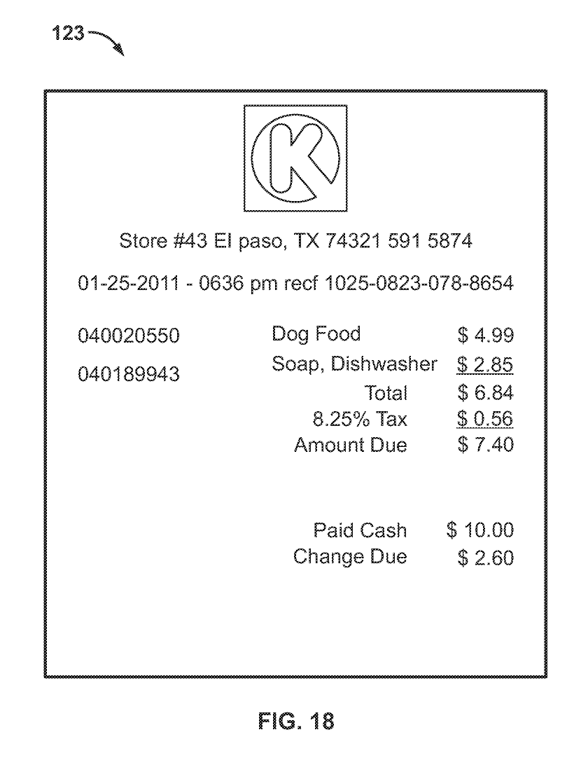

FIG. 17 illustrates a schematic diagram of the path that a specific transaction set can follow from the Federal Reserve Bank 92 to the appropriate participants account through existing infrastructure, in accordance with the disclosed embodiments. In the scenario shown in FIG. 17, a transaction that was created by the cash register operator and uploaded to the Federal Reserve Bank 92 for processing was effective Feb. 15, 2011, and the graphic illustrates the FRB 92 releasing those transactions to the downstream DFI's. Credit to a customer's #1 account is indicated in FIG. 17 by block 119, and credit to the customer's #2 account is indicated by block 121. Block 111 indicates a debit to the customer's account (e.g., a virtual coin purse or other account).

FIG. 18 depicts a sample receipt 123, in accordance with the disclosed embodiments. The sample receipt 123 shown in FIG. 18 is, again like the receipt shown in FIG. 7, from a fictitious store #43 of the Circle K convenience store chain located in El Paso Tex. The fictitious zip code and telephone number are included as well as two purchases totaling $6.84. In Texas, for example, a sales tax of 8.25% is applicable, the receipt reflects that tax amount of $0.56, and the total sale amount of $7.40. The amount of cash tendered (e.g., $10,00) and the change due ($2.60) the customer are printed as well on the sample receipt.

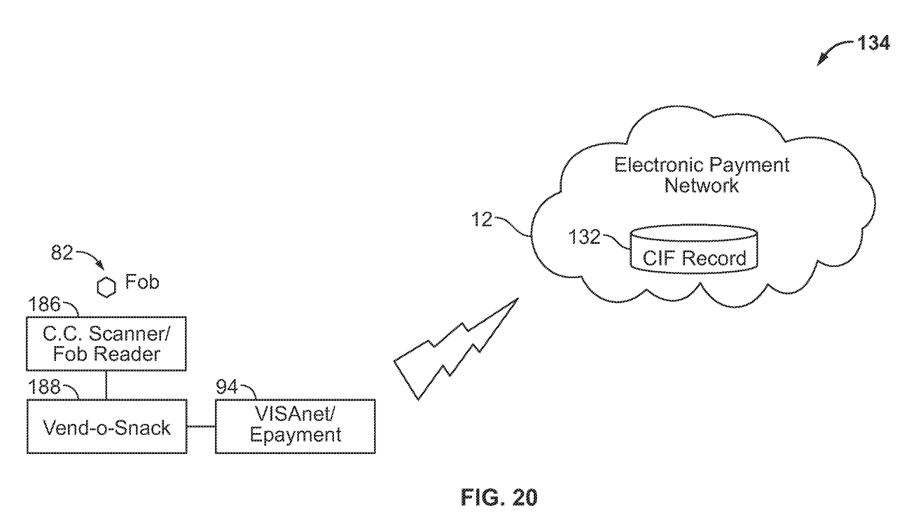

FIG. 19 illustrates a schematic diagram of a system 130, in accordance with the disclosed embodiments. A CIF record 132, shown in FIG. 19, is maintained in a database such as database 17 described earlier. Data from the federal reserve bank 92 can be retrieved and transmitted through the electronic payment network 12.

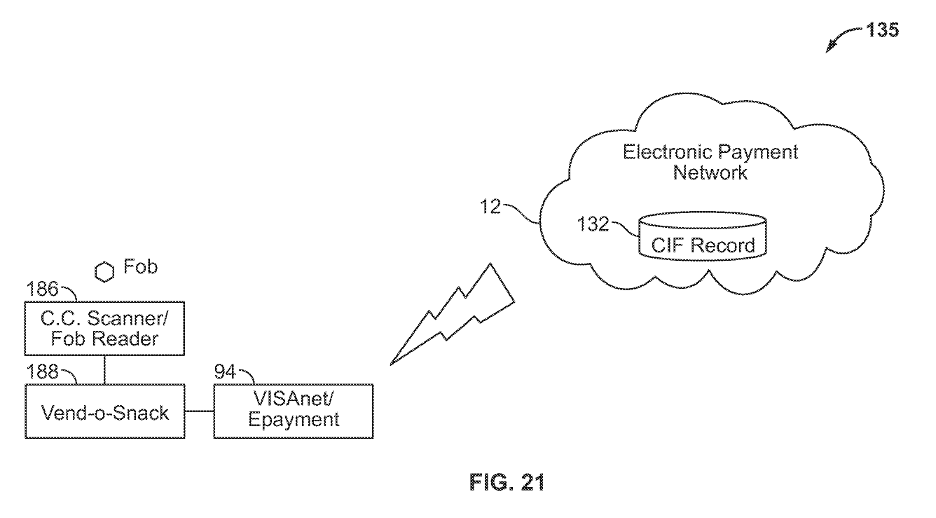

FIGS. 20-21 respectively illustrate schematic diagrams of systems 134, 135 indicating communication between the electronic payment network 12 and a vending machine 188 that communicates with an e-payment module 94 and a credit card scanner/fob reader 186 with respect to a portable hand held device 82 (e.g., a fob, smartphone, smart card, etc.).

Note that one example of a vending machine and communications means thereof, such as the Internet, that can be adapted for use in accordance with an embodiment is disclosed in U.S. Pat. No. 7,889,852, which issued to Stephen Craig Whitehead on Feb. 15, 2011 and is entitled “Remote Communications With a Vending Machine Using Call Back”. U.S. Pat. No. 7,889,852 is incorporated herein by reference in its entirety. Another example of a vending machine that can be adapted for use in accordance with an alternative embodiment is disclosed in U.S. Pat. No. 7,593,897, which issued to H. Brock Kolls on Sep. 22, 2009 and is entitled, “Wireless System for Communicating Cashless Vending Transaction Data and Vending Machine Audit Data to Remote Locations.” U.S. Pat. No. 7,593,897 is incorporated herein by reference in its entirety.

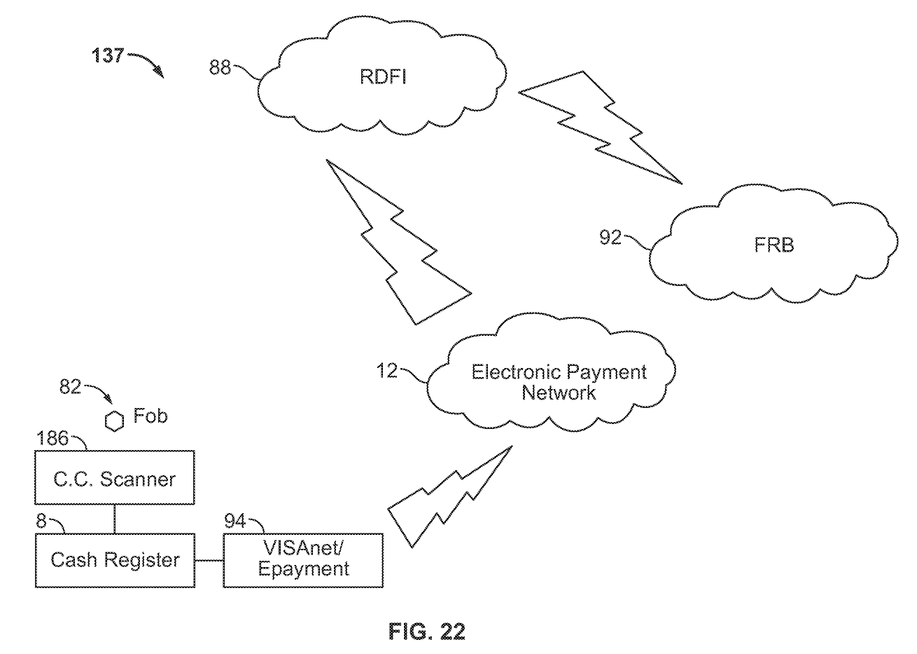

FIG. 22 illustrates a schematic diagram of a system 137, in accordance with the disclosed embodiments. System 137 includes, for example, the use of a cash register 8 connected to e-payment module 94 and also to a credit card scanner 186 (or an fob scanner or other appropriate scanning or communications device) with respect to fob 82. Communications are also shown between RDFI (Receiving Depository Financial Institution) 88, Federal Reserve Bank 92, and the electronic payment network 12, which also communicates with the cash register 8 via the e-payment module 94. It can be appreciated, of course, that the cash register 8 can also be replaced with the vending machine 188 shown in FIGS. 21-22.

Currently, Financial Institutions or their service bureau providers create a file daily that contains balance information for all accounts associated with an ATM card. This Customer Information File (CIF) is “published” to the ATM network (FIG. 19) every day so that balances for accounts are current and made available to the ATM network for funds verification and purchases. When you use an ATM and, for example, you're withdrawing funds, the ATM machine compares the amount you are trying to withdraw to the balance documented in the CIF file, If there are available funds reflected in the CIF file, then the machine allows the transaction to occur. The ATM then “memo posts” the amount withdrawn into the ATM network so that your available balance reflects the withdrawal.

Traditional “Coin” operated vending/service machines (public phones, snack vending, parking meters, etc.) can be equipped with a computer and connected via telephone line(s) or other suitable communications protocol to the ATM network. Additionally, these ATM connected vending/service machines would have a fob reader installed and the vending version of the exchange software that would allow coinless vending. For example, if a customer wanted to purchase a snack from vending machine 188, they would pass their fob by the fob reader. The fob reader would capture the data on the fob (ABA, account #) and access the CIF record (FIG. 20) to compare the customer's available funds to the highest priced item for sale in the machine (FIG. 21). If the customer had the appropriate funds in their account, the machine would enable the user to select an item for purchase and “write” the amount of sale along with the fob data into a POS ACH type file. The amount of sale would be “memo posted” to the customer's account in the ATM network so that the available balance in the ATM Network reflects the current available balance. The POS ACH file would be transmitted through the VISAnettACH network the same as any POS file (FIG. 22), however it would originate from the vending/service machine.

Based on the foregoing, it can be appreciated that varying embodiments are disclosed. For example, in one embodiment, a method can be implemented for converting coins at a point-of-sale into electronic funds. Such a method can include, for example, accepting cash from a payer for payment of a transaction at a point-of-sale together with identifying information for a virtual coin purse associated with the payer; reconciling an amount due for payment and an amount due as change for a settlement of the transaction at the point-of-sale; and crediting the virtual coin purse associated with the payer in a form of electronic funds for change due in lieu of coins with respect to the transaction.

In another embodiment, the step of reconciling the amount due for payment and the amount due as change for the settlement of the transaction, can further comprise categorizing the amount due as change, an amount due as bills, and an amount due as the coins. Additionally, a step can be provided for providing the bills to the payer and another step for directing the amount due as coins as electronic funds to the virtual coin purse. Additionally, the virtual coin purse can be stored as an account stored in a server. Also, in other embodiments, the server can be managed by a third-party provider. In some embodiments, the third-party provider can comprise, for example, a financial institution, a credit card company, a rewards/loyalty account provider, a coupon redemption enterprise, and so forth.

One example of a third-party provider is disclosed in U.S. Pat. No. 7,209,733 entitled “Credit Manager Method and System,” which issued to Ortiz et al. on Apr. 24, 2007 and is incorporated herein by reference in its entirety. Another example of a third party provider, specifically a loyalty points/rewards type provider, is disclosed in U.S. Pat. No. 7,686,218 entitled “System and Method for Exchanging Loyalty Points for Acquisitions,” which issued to Hessburg et al., on Mar. 30, 2010 and is incorporated herein by reference in its entirety.

In some embodiments, the virtual coin purse can comprise data stored on a portable hand held device. The portable hand held device can be, for example, a Smartphone, a fob, a smart card, a standard smart card, an RFID enabled smart card, etc. In some cases, the portable hand held device can further comprise bar code indicia associated with an account stored in a secured server. Additionally, the payer can be authenticated with respect to the transaction. Note that the point-of-sale can be, for example, an online store, a cash register, a vending machine, a payment mechanism associated with publication transportation (e.g., bus, subway, ferry, etc), a gas pump, and so forth.

In other embodiments, a method for engaging in a transaction using virtual funds can be implemented. Such a method can include, for example, selecting goods or services at a point-of-sale for a transaction; receiving from the point-of-sale an amount due with respect to the goods or services selected; providing electronic cash from a virtual coin purse associated with a payer; settling the transaction utilizing the electronic funds from the virtual coin purse; and updating a current balance of the virtual coin purse.

Additionally, as indicated earner, the point-of-sale can comprise, for example, an online store, a vending machine, a payment mechanism associated with public transportation, a cash register, gas pump, etc. In some embodiments, the vending machine can comprise a data communication network connection in order to access a remote server containing account information associated with the virtual coin purse and a user interface to collect the account information associated with the virtual coin purse from a payer. In yet other embodiments, the account information can be provided from the payer via a biometric reading from the payer.

In still other embodiments, a system for converting coins at a point-of-sale into electronic funds can be implemented. Such a system can include, for example, a processor; a data bus coupled to the processor; and a computer-usable medium embodying computer code, the computer-usable medium being coupled to the data bus. The computer program code can comprise instructions executable by the processor and configured for: accepting cash from a payer for payment of a transaction at a point-of-sale together with identifying information for a virtual coin purse associated with the payer; reconciling an amount due for payment and an amount due as change for a settlement of the transaction at the point-of-sale: and crediting the virtual coin purse associated with the payer in a form of electronic funds for change due in lieu of coins with respect to the transaction.

In some embodiments, the instructions for reconciling the amount due for payment and the amount due as change for the settlement of the transaction can be further configured for categorizing the amount due as change, an amount due as bills, and an amount due as the coins. Such instructions can also be configured for providing the bills to the payer. Such instructions can also be further configured for directing the amount due as coins as electronic funds to the virtual coin purse. Such instructions can also be in some embodiments, further configured for both providing the bills to the payer and directing the amount due as coins as the electronic funds to the virtual coin purse.

In some embodiments, the virtual coin purse can comprise an account stored in a server. Such a server may be managed by a third-party provider. Examples of third-party providers are financial institutions, credit card companies, etc, As indicated previously, the virtual coin purse can be stored on a portable hand held device. Such a portable hand held device can be, for example, a Smartphone, a fob, an RFID enabled smart card that permits near field communications, bar code indicia associated with an account stored in a secured server, and so forth.

In another example, such instructions can be further configured for authenticating the payer with respect to the transaction, Such instructions can be further configured for procuring goods or services. As indicated previously, the point-of-sale can be, for example, an online store, a kiosk, a vending machine, a cash register, a gas pump, a payment mechanism associated with public transportation, etc.

In still another embodiment, a system for engaging in a transaction using virtual funds can be provided. Such a system can include, for example, a processor; a data bus coupled to the processor; and a computer-usable medium embodying computer code, the computer-usable medium being coupled to the data bus. The computer program code can comprise instructions executable by the processor and configured for: selecting goods or services at a point-of-sale for a transaction; receiving from the point-of-sale an amount due with respect to the goods or services selected; providing electronic cash from a virtual coin purse associated with a payer; settling the transaction utilizing the electronic funds from the virtual coin purse; and updating a current balance of the virtual coin purse.

Again, the point-of-sale can be, for example, an online store, a kiosk, a vending machine, a cash register, a gas pump, a payment mechanism associated with public transportation, etc. In some embodiments, the vending machine can comprise a data communication network connection in order to access a remote server containing account information associated with the virtual coin purse and a user interface to collect the account information associated with the virtual coin purse from a payer. In some embodiments, the account information can be provided from the payer via a biometric reading from the payer.

In another embodiment, a processor-readable medium can be provided for storing code representing instructions to cause a processor to perform a process to convert coins at a point-of-sale into electronic funds. Such code can comprise of code to accept cash from a payer for payment of a transaction at a point-of-sale together with identifying information for a virtual coin purse associated with the payer; reconcile an amount due for payment and an amount due as change for a settlement of the transaction at the point-of-sale; and credit the virtual coin purse associated with the payer in a form of electronic funds for change due in lieu of coins with respect to the transaction.

In other embodiments, the code comprising of code to reconcile the amount due for payment and the amount due as change for the settlement of the transaction can further comprise of code to automatically categorize the amount due as change, an amount due as bills, and an amount due as the coins. In yet other embodiments, such code can further comprise of code to provide the bills to the payer and to direct the amount due as coins as electronic funds to the virtual coin purse.

In yet other embodiments, such code can comprise of code to configure the virtual coin purse as an account stored in a server. In still other embodiments, such code can comprise of code to manage the server by a third-party provider. As indicated previously, such a third-party provide can be, for example, a financial institution, a credit card company, a rewards/point organization, a couponing organization/company, and so forth.

In other embodiments, the code can comprise of code to configure the virtual coin purse to comprise of data stored on a portable hand held device. Such a portable hand held device can be, for example, a Smartphone, a fob, a smart card, etc. In other embodiments, the portable hand held device can comprise of bar code indicia associated with an account stored in a secured server. In other embodiments, the code can further comprise of code to authenticate the payer with respect to the transaction. In still other embodiments, the code can further comprise of code to procure goods or services. Additionally, as indicated previously, the point-of-sale can be, for example, an online store, a vending machine, a payment mechanism associated with public transportation, a cash register, etc.

In still another embodiment, a processor-readable medium can be provided for storing code representing instructions to cause a processor to perform a process to engage in a transaction using virtual funds. In such an alternative embodiment, the code can comprise of code to select goods or services at a point-of-sale for a transaction; receive from the point-of-sale an amount due with respect to the goods or services selected; provide electronic cash from a virtual coin purse associated with a payer; settle the transaction utilizing the electronic funds from the virtual coin purse; and update a current balance of the virtual coin purse.

As indicated previously, the point-of-sale can be, for example, an online store, a vending machine, a payment mechanism associated with public transportation, a cash register, etc. In some embodiments, the vending machine may include a data communication network connection in order to access a remote server containing account information associated with the virtual coin purse and a user interface to collect the account information associated with the virtual coin purse from a payer. In still other embodiments, the account information can be provided from the payer via a biometric reading from the payer.

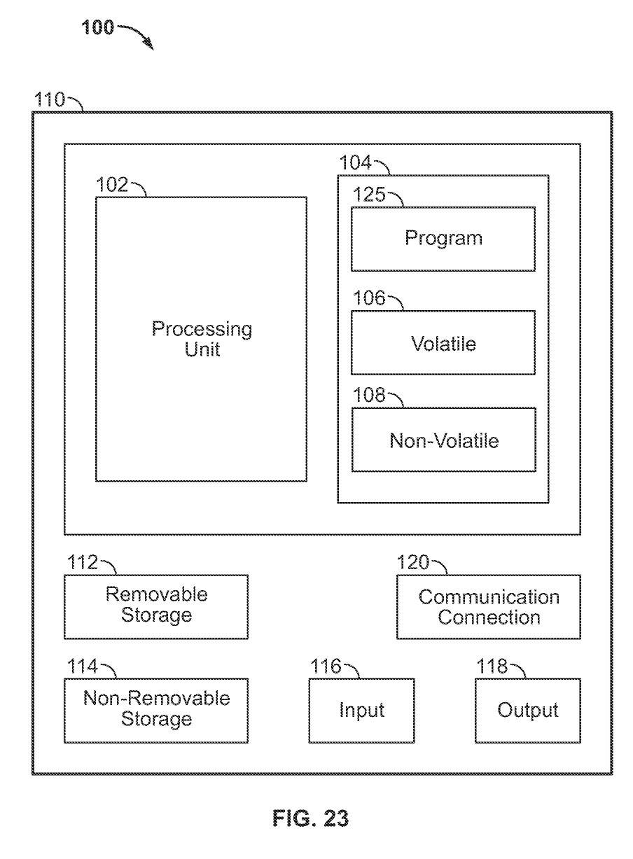

FIG. 23 illustrates a block diagram of a computer system 100 that can be utilized to execute programming for executing the methods, systems and/or processor-readable media disclosed herein. A general computing device in the form of a computer 110 may include a processing unit 102, memory 104, removable storage 112, and non-removable storage 114. The memory 104 may include volatile memory 106 and non-volatile memory 108. The computer 110 may include or have access to a computing environment that includes a variety of computer-readable media such as volatile memory 106, non-volatile memory 108, removable storage 112, and non-removable storage 114. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions, as well as data, including video frames.

The computer 110 may include or have access to a computing environment that includes input 116, output 118, and a communication connection 120. The computer may operate in a networked environment using a communication connection 120 to connect to one or more remote computers. The remote computer may include a personal computer (PC), server, router, network PC, a peer device or other common network node, or the like. The communication connection 120 may include a Local Area Network (LAN), a Wide Area Network (WAN) or other networks. This functionality is described in more detail in FIG. 23.

The output 118 is most commonly provided as a computer monitor, but may include any computer output device. The output 118 allows a user to navigate through the virtual environment embodied by computer system 100. In addition, the input 116, which commonly includes a computer keyboard and/or pointing device such as a computer mouse, allows a user to select and instruct computer system 100. A user interface can be provided using the output 118 and input 116.

Processor-readable or computer-readable instructions, for example, program module 125, are stored on a computer-readable medium and are executable by the processing unit 102 of computer 110. The program module 125 may include an application. A hard drive, CD-ROM, RAM, Flash Memory, and a USB drive are just some examples of articles including a computer-readable medium.

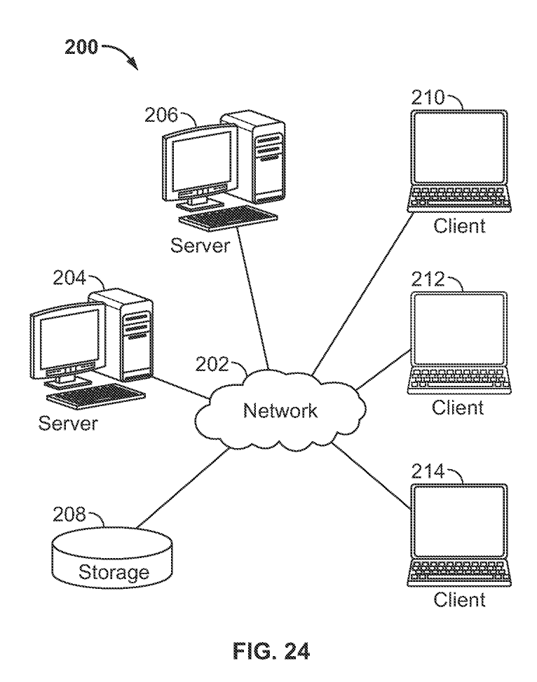

FIG. 24 depicts a graphical representation of a network of data-processing systems 200 in which aspects of the disclosed embodiments may be implemented. Network data-processing system 200 is a network of computers in which embodiments may be implemented, Note that the system 200 can be implemented in the context of a software module such as program module 125. The system 200 includes a network 202 in communication with one or more clients 210, 212, and 214. The network 202 is a medium that can be used to provide communication links between various devices and computers connected together within a networked data processing system such as computer system 100. The network 202 may include connections such as wired communication links, wireless communication links, or fiber optic cables. The network 202 can further communicate with one or more servers 204 and 206 and a memory storage unit such as, for example, memory or database 208.

In the depicted example, server 204 and server 206 connect to network 202 along with storage unit 208. In addition, clients 210, 212, and 214 connect to network 202. These clients 210, 212, and 214 may be, for example, personal computers or network computers. The computer system 100 depicted in FIG. 23 can be, for example, a client such as client 210, 212, and/or 214. Alternatively, computer system 100 can be implemented as a server such as servers 204 and/or 206, depending upon design considerations.

In the depicted example, server 204 provides data such as boot files, operating system images, applications, and application updates to clients 210, 212, and 214. Clients 210, 212, and 214 are clients to server 204 in this example. The network data-processing system 200 may include additional servers, clients, and other devices not shown. Specifically, clients may connect to any member of a network of servers, which provide equivalent content.

In the depicted example, network data-processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 200 also may be implemented as a number of different types of networks such as for example, an intranet, a local area network (LAN), or a wide area network (WAN). FIG. 24 is intended as an example and not as an architectural limitation for different embodiments disclosed herein.

The aforementioned description has thus been presented with respect to preferred and alternative embodiments of the present invention, which can be embodied in the context of a data-processing system such as computer system 100, in conjunction with program 125, and data-processing system 200 and network 202 depicted in FIGS. 23 and 24. The present invention, however, is not limited to any particular application or any particular environment, Instead, those skilled in the art will find that the systems, methods and processor-readable media described herein may be advantageously applied to a variety of system and application software including database management systems, word processors, and the like. Moreover, the systems, methods and processor-readable media disclosed herein may be embodied on a variety of different platforms including Macintosh, UNIX, LINUX, and the like. Therefore, the descriptions of the exemplary embodiments, which follow, are for purposes of illustration and not considered a limitation of the disclosed embodiments.

It will be understood that the circuits and other means supported by each block and combinations of blocks can be implemented by special purpose hardware, software or firmware operating on special or general-purpose data processors, or combinations thereof. It should also be noted that, in some alternative implementations, the operations noted in the blocks may occur out of the order noted in the figures. For example, two blocks shown in succession may, in fact, be executed substantially concurrently, or the blocks may sometimes be executed in the reverse order.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A method for converting coins at a point-of-sale into electronic funds, said method comprising:
accepting cash from a payer for payment of a transaction at a point-of-sale together with identifying information for a virtual coin purse associated with said payer;
reconciling an amount due for payment and an amount due as change for a settlement of said transaction at said point-of-sale; and
crediting said virtual coin purse associated with said payer in a form of electronic funds for change due in lieu of coins with respect to said transaction.

2. The method of claim 1 wherein reconciling said amount due for payment and said amount due as change for said settlement of said transaction, further comprises:
categorizing said amount due as change, an amount due as bills, and an amount due as said coins.

3. The method of claim 2 further comprising providing said hills to said payer.

4. The method of claim 2 further comprising directing said amount due as coins as electronic funds to said virtual coin purse.

5. The method of claim 2 further comprising:
providing said bills to said payer; and
directing said amount due as coins as said electronic funds to said virtual coin purse.

6. The method of claim 1 further comprising configuring said virtual coin purse as an account stored in a server.

7. The method of claim 6 further comprising managing said server by a third-party provider.

8. A system for converting coins at a point-of-sale into electronic funds, said system comprising:
a processor;
a data bus coupled to said processor; and
a computer-usable medium embodying computer code, said computer-usable medium being coupled to said data bus, said computer program code comprising instructions executable by said processor and configured for:
accepting cash from a payer for payment of a transaction at a point-of-sale together with identifying information for a virtual coin purse associated with said payer;
reconciling an amount due for payment and an amount due as change for a settlement of said transaction at said point-of-sale; and
crediting said virtual coin purse associated with said payer in a form of electronic funds for change due in lieu of coins with respect to said transaction.

9. The system of claim 8 wherein said instructions for reconciling said amount due for payment and said amount due as change for said settlement of said transaction, are further configured for:
categorizing said amount due as change, an amount due as bills, and an amount due as said coins.

10. The system of claim 9 wherein said instructions are further configured for providing said bills to said payer.

11. The system of claim 9 wherein said instructions are further configured for directing said amount due as coins as electronic funds to said virtual coin purse.

12. The system of claim 9 wherein said instructions are further configured for:
providing said bills to said payer; and
directing said amount due as coins as said electronic funds to said virtual coin purse.

13. The system of claim 8 wherein said virtual coin purse comprises an account stored in a server.

14. The system of claim 13 wherein said instructions are further configured for managing said server by a third-party provider.

15. A processor-readable medium storing code representing instructions to cause a processor to perform a process to convert coins at a point-of-sale into electronic funds, said code comprising of code to:
accept cash from a payer for payment of a transaction at a point-of-sa e together with identifying information for a virtual coin purse associated with said payer;
reconcile an amount due for payment and an amount due as change for a settlement of said transaction at said point-of-sale; and
credit said virtual coin purse associated with said payer in a form of electronic funds for change due in lieu of coins with respect to said transaction.

16. The processor-readable medium of claim 15 wherein said code comprising of code to reconcile said amount due for payment and said amount due as change for said settlement of said transaction, further comprises of code to:
automatically categorize said amount due as change, an amount due as bills, and an amount due as said coins.

17. The processor-readable medium of claim 16 wherein said code further comprises of code to provide said bills to said payer.

18. The processor-readable medium of claim 16 wherein said code further comprises of code to direct said amount due as coins as electronic funds to said virtual coin purse.

19. The processor-readable medium of claim 16 wherein said code further comprises of code to:
provide said bills to said payer; and
direct said amount due as coins as said electronic funds to said virtual coin purse.

20. The processor-readable medium of claim 15 wherein said code further comprises of code to configure said virtual coin purse as an account stored in a server.
